(19) United States
(12) Patent Application Publication
(10) Pub. No.: US 2014/0376409 A1
(43) Pub. Date: Dec. 25, 2014

(54) ROUTING METHOD AND APPARATUS

(71) Applicant: ELECTRONICS AND TELECOMMUNICATIONS RESEARCH INSTITUTE, DAEJEON (KR)

(72) Inventors: Tae Ho LEE, Daejeon (KR); Byeongok KWAK, Daejeon (KR); Woojik CHUN, Seoul (KR)

(21) Appl. No.: 14/307,562

(22) Filed: Jun. 18, 2014

(30) Foreign Application Priority Data
Jun. 24, 2013 (KR) 10-2013-0072638

(51) Int. Cl. H04L 12/751

(52) U.S. Cl. CPC H04L 45/02
USPC 370/255

(57) ABSTRACT

In an ID-based communication system, a routing apparatus creates a hierarchical network topology by using link state information on higher-level domains, lower-level domains, and peer domains. The routing apparatus then makes a routing table based on the hierarchical network topology, and performs routing by using the routing table.

### CROSS-REFERENCE TO RELATED APPLICATION

This application claims priority to and the benefit of Korean Patent Application No. 10-2013-0072635 filed in the Korean Intellectual Property Office on Jun. 24, 2013, the entire contents of which are incorporated herein by reference.

### BACKGROUND OF THE INVENTION

1. Field of the Invention

The present invention relates to a routing method, and more particularly, to a method and apparatus for routing in an ID-based communication system.

2. Description of the Related Art

In the context of the current Internet, routing is the process of selecting paths in a network to systematically determine how to forward messages (packets) to their destinations, based on their addresses. A device that actively performs this process is called a router, and a database (list) for path selection is called a routing table. The routing table contains destination network addresses, information on the output port of the router, metrics for calculating the best path, etc. That is, routing encompasses a set of operations for creating a routing table required to calculate the best path.

The explosive growth of the internet is now confronting severe internet scalability issues. It is assumed that the trend of increasing inter-domain BGP (border gateway protocol) routing tables has lead to the Internet scalability issues. With the progress toward ubiquitous networks, network complexity is growing due to the emergence of various kinds of terminals and the rapid increase in the number of terminals. Thus, network scalability is one of the most basic requirements. As backbone routing information is rapidly increasing on the Internet, there is an urgent need for solutions to this problem. Such scalability problems arise because de-aggregation addresses flow into Internet backbone areas due to allocation of ISP (internet service provider)-independent addresses, multi-homing, traffic engineering, and so on. This results in unnecessary processes for the management of these addresses and an increase in the lengths of address blocks (prefixes).

### SUMMARY OF THE INVENTION

The present invention has been made in an effort to provide a routing method and apparatus which organizes a network topology hierarchically according to link status information by using a fisheye technique, and perform routing based on the network topology.

In addition, the present invention has been made in an effort to provide a routing method and apparatus which prevent performance degradation caused by an increase in the number of routing tables, by searching for routing paths based on hierarchical network topology information and managing only the found paths as message forwarding paths.

An exemplary embodiment of the present invention provides a method for routing in an ID-based communication system, the method including: creating a hierarchical network topology by using link state information on higher-level domains, lower-level domains, and peer domains; making a routing table based on the hierarchical network topology; and performing routing by using the routing table, wherein the routing table stores address information for a destination domain.

The address information for the destination domain may include the ID and address of the gateway for a next hop, corresponding to the destination domain.

The creating of a hierarchical network topology may include: sending a notification about the link state of level n, along with a single domain ID assigned to the domains at level n, to a first domain at level n−1 of the link state of level n from a gateway connected to a domain at level n, each domain having one or more gateways which connect to the outside; sending a notification about the link state of a peer domain at level n−1 to the first domain from the peer domain; and creating a network topology, based on the link state notifications, by a routing apparatus of a gateway connected to the first domain at level n−1.

The domain ID assigned to the domains at level n may indicate that the domains at level n are a single node belonging to level n−1. The routing method may further include forwarding all the link state notifications from the domains at level n−1 and level n to a domain at level n+1.

In the creating of a hierarchical network topology, the hierarchical network topology may be created based on a fisheye technique.

The performing of routing may include: receiving an ID of a destination node by a source node's routing apparatus; searching for a destination domain ID by searching the routing table based on the ID of the destination node; selecting next hop address information mapped to the destination domain ID from the routing table; and transmitting the ID and location information of the destination node to a gateway corresponding to the next hop address information.

In this case, the routing method may further include storing and managing the destination domain ID and the next hop address information mapped thereto in a forwarding cache table.

Another exemplary embodiment of the present invention provides an apparatus for routing in an ID-based communication system, the apparatus including: a link state manager that manages link state information on higher-level domains, lower-level domains, and peer domains; a topology manager that creates a hierarchical network topology by using the link state information; a routing table manager that makes a routing table based on the hierarchical network topology and stores and manages the routing table; and a path search processor that performs a path search by using the routing table, wherein the routing table stores address information for a destination domain.

The address information for the destination domain may include the ID and address of the gateway for a next hop, corresponding to the destination domain.

The topology manager may create a network topology, based on the link state of a higher level, along with a single domain ID assigned to the domains at the higher level, received from a gateway connected to a domain at the higher level, and the link state of a peer domain at the same level received from the peer domain, and the single domain ID assigned to the domains at the higher level n may indicate that the domains at the level n are a single node belonging to the level where the routing apparatus is located.

The path search processor may search for a destination domain ID by searching the routing table based on the ID of the destination node, and transmit the ID and location information of the destination node to a gateway corresponding to next hop address information mapped to the destination domain ID from the routing table.

The routing apparatus may further include forwarding cache storage that stores and manages the destination domain ID and the next hop address information mapped thereto in a forwarding cache table.

### BRIEF DESCRIPTION OF THE DRAWINGS

FIG. 1 is a view showing a network topology structure.

FIG. 2 is a view schematically showing a network topology based on node A.

FIG. 3 is a view showing a network topology viewed with respect to node A from a fisheye perspective in accordance with an exemplary embodiment of the present invention.

FIG. 4 is a view showing a network topology having a hierarchical domain structure in accordance with an exemplary embodiment of the present invention.

FIG. 5 is an illustration showing a link state notification process in accordance with an exemplary embodiment of the present invention.

FIG. 6 is a view showing a structure of a routing apparatus in accordance with an exemplary embodiment of the present invention.

FIG. 7 is a flowchart of a routing method in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, the term “node” may designate a terminal, a mobile terminal (MT), user equipment (UE), an access terminal (AT), a router, a gateway (GW), etc., or may include all or some functions of the terminal, MT, UE, AT, router, GW, etc.

Hereinafter, a routing method and apparatus in accordance with an exemplary embodiment of the present invention will be described with reference to the drawings.

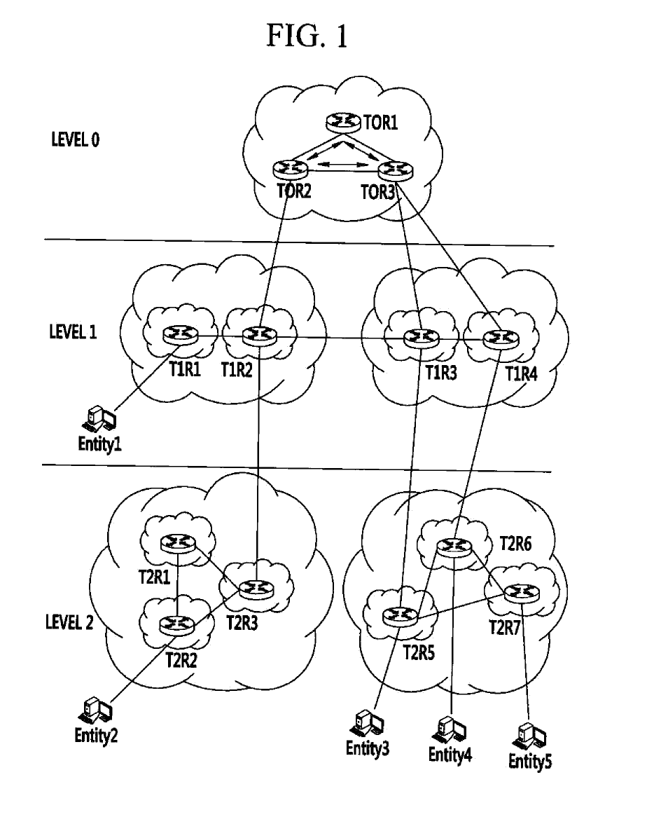

FIG. 1 is a view showing a network topology structure.

As shown in the accompanying FIG. 1, a network topology has a hierarchical structure based on the top-level domain, and a parent-child relationship is established between domain systems. One domain system may have a plurality of parents to prepare for performance improvement and against performance degradation, and may also establish a peer-to-peer relationship with another domain system.

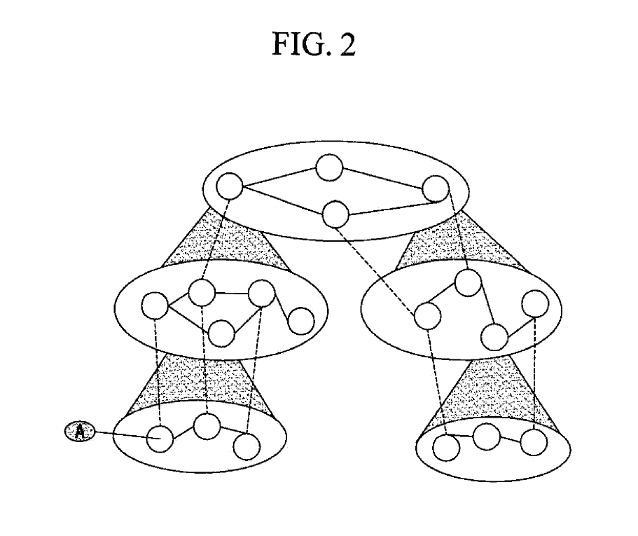

Such a network topology will be shown schematically in FIG. 2, with reference to a single node A.

FIG. 2 is a view schematically showing a network topology based on node A.

From the perspective of node A, the domain containing node A is the lowermost node. The domain containing node A and domains connected to thereto are connected as peer domains, and a domain connected to a higher level appears to be a single node representing the peer domains.

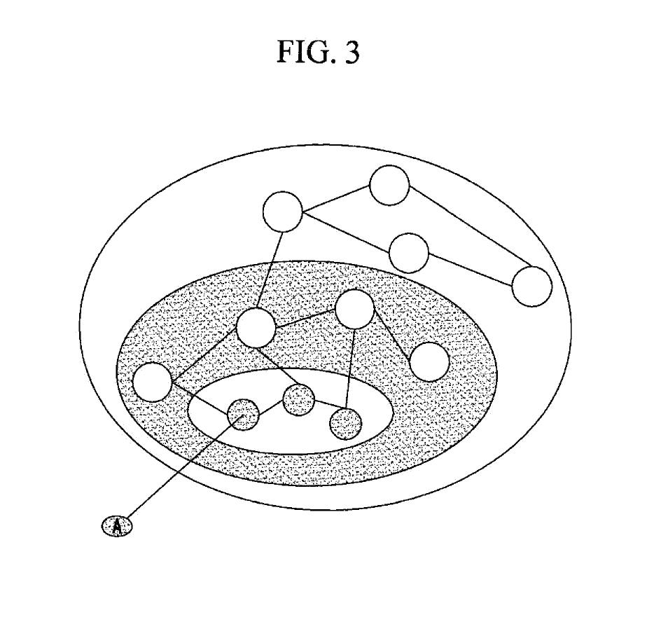

From the perspective of node A, domains at a higher level appear to be a single connected node. The shape of the topology viewed from the perspective of node A is as shown in FIG. 3.

FIG. 3 is a view showing a network topology viewed with respect to node A from a fisheye perspective in accordance with an exemplary embodiment of the present invention.

In an exemplary embodiment of the present invention, the global topology of the entire network is organized from the fisheye perspective, by using link state information on higher-level domains, lower-level domains, and peer domains.

From the fisheye perspective, nearby domains are highly visible, and distant domains are not visible, except for representative domains. From this perspective, nodes belonging to, one domain can see detailed information about routing and detailed topology information, and nodes belonging to a domain outside this domain are at a distance and are visible only from the perspective of paths. In an exemplary embodiment of the present invention, the size of the graph of the entire network topology can be scaled down by organizing a global topology from this perspective.

In an exemplary embodiment of the present invention, a network topology is organized as follows, from the fisheye perspective.

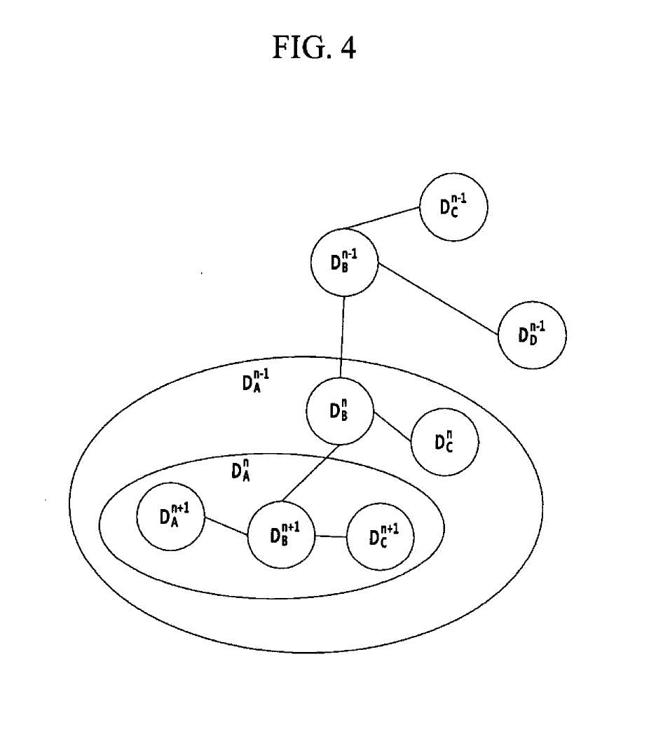

FIG. 4 is a view showing a network topology having a hierarchical domain structure in accordance with an exemplary embodiment of the present invention.

In an exemplary embodiment of the present invention, each domain has one or more gateways connected to its outside.

From the perspective of node D_{B}ⁿ⁻¹ at level n−1, the inside of a domain (node D_{B}ⁿ) at level n is hidden. To create a topology graph at level n−1, as shown in FIG. 4, domains (e.g., D_{A}ⁿ, D_{B}ⁿ, and D_{C}ⁿ) at level n are abstracted as a single node (e.g., D_{A}ⁿ⁻¹) at level n−1. Each domain may be abstracted as a node having a domain ID as its own identifier. That is, the domains at level n are recognized as a node having the domain ID of D_{A}ⁿ⁻¹ with respect to level n−1.

As the configuration of a domain is cyclically defined, the definitions of a node and a domain are interchangeably used depending on perspectives. That is, a domain at a certain level is viewed and abstracted as a node at a higher level. With this cyclic structure, domains can be configured in a hierarchical manner as shown in FIG. 4.

In an exemplary embodiment of the present invention, a link state notification is sent, along with a filtering rule based on a level number assigned to the gateway of each domain, in order to organize a fisheye-based network topology.

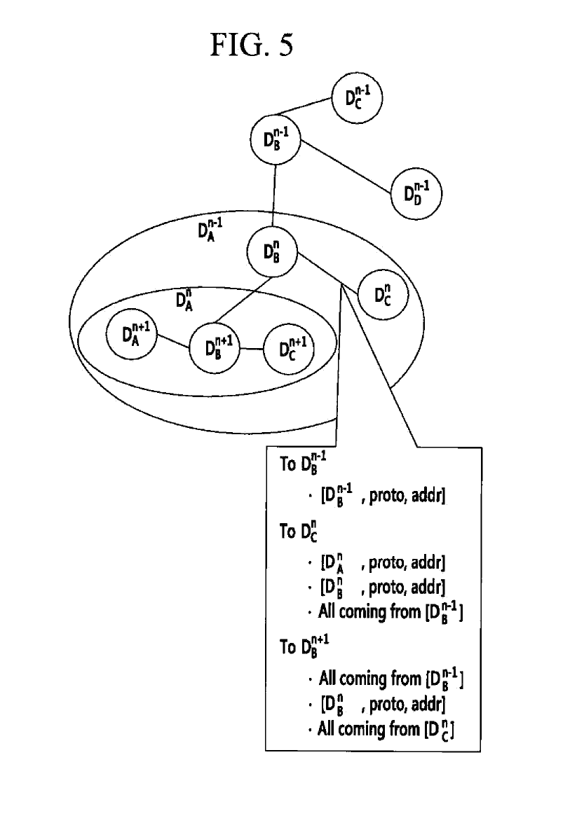

FIG. 5 is an illustration showing a link state notification process in accordance with an exemplary embodiment of the present invention.

Each domain has one or more gateways which connect to the outside. The gateway of each domain sends a link state notification. When a gateway connected to a domain at level n notifies a domain at level n−1 of the link state of level n, the gateway also informs that it is part of the level n by forwarding the domain ID D_{A}ⁿ⁻¹ of level n. A peer domain at level n is notified of the link state of another peer domain. In addition, the gateway receives link state information from level n−1, and notifies a peer domain at level n about the reception.

For example, as illustrated in the accompanying FIG. 5, when a gateway connected to the domain D_{B}ⁿ at level n notifies the domain D_{B}ⁿ⁻¹ at level n−1 of the link state, it sends a link state notification, along with the domain ID D_{A}ⁿ⁻¹ of level n. Moreover, it notifies a peer domain D_{C}ⁿ at the same level n of the link state of another peer domain D_{A}ⁿ, its own link state, and the link state forwarded from the domain D_{B}ⁿ⁻¹ at level n−1.

By this procedure, all the link state notifications from the domains at level n−1 and level n are forwarded to level n+1. For example, as shown in FIG. 5, all the link state notifications from the domains D_{B}ⁿ⁻¹, D_{B}ⁿ, and D_{C}ⁿ at level n−1 and level n are forwarded to the domain D_{B}ⁿ⁻¹ at level n+1.

Based on the above-described link state notification process, a fisheye-based network topology is organized. The gateway of each domain organizes a network topology based on the link states notified in the above manner.

A routing apparatus in accordance with an exemplary embodiment of the present invention performs routing based on the thusly-organized network topology.

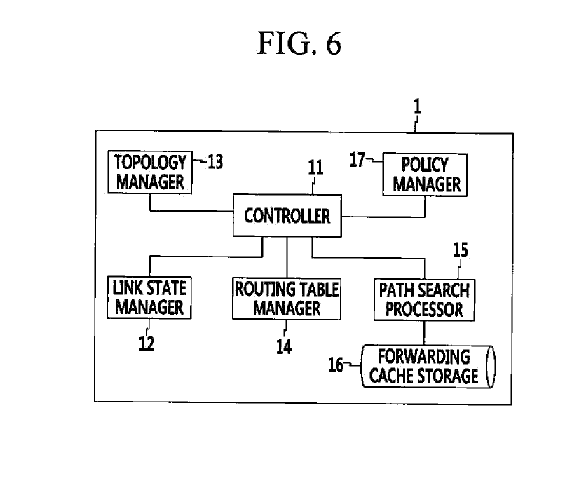

FIG. 6 is a view showing a structure of a routing apparatus in accordance with an exemplary embodiment of the present invention.

As shown in the accompanying FIG. 6, a routing apparatus 1 in accordance with an exemplary embodiment of the present invention includes a controller 11, a link state manager 12, a topology manager 13, a routing table manager 14, and a path search processor 15. In addition, the routing apparatus 1 may further include a forwarding cache storage 16 and a policy manager 17.

The controller 11 receives link state information from the routing apparatus (not shown) of a terminal or an upper- or lower-level node, and forwards it to the link state manager 12, and forwards the link states of domains it manages to the routing apparatus of the upper- or lower-level node.

The link state manager 12 manages the link states of lower-level and higher-level nodes belonging to its coverage area, and also forwards link state information to the topology manager 13 so that the topology manager 13 organizes a global network topology.

The topology manager 13 performs management tasks as described above, from the fisheye perspective, based on the link state information about upper and lower domains and peer domains, which is provided from the link state manager 12, thereby organizing the global topology of the entire network. From the fisheye perspective, detailed information about routing and detailed topology information are configured for nodes belonging to their own domain, and nodes belonging to a domain outside this domain are handled only from the perspective of paths, thereby organizing a global topology. By doing so, the size of the graph of the entire network topology can be scaled down.

Meanwhile, the routing table manager 14 stores and manages address information for destination domains by individual routers, based on the network topology. The routing table manager 14 manages address information for a specific destination domain, rather than including routing information for all network addresses.

Here, the address information indicates a domain ID with a locator function. Specifically, the routing table stores the next hop address destined for the domain ID, corresponding to the domain ID functioning as a locator. For example, the routing table stores the address of the next hop address destined for the domain D_{B}ⁿ. Further, the routing table additionally contains the number of hops and path information. If the path search processor 15 searches for a path to a target communication object, the routing table manager 14 provides next hop address information so as to find a route to the destination.

The following Table 1 is an example of a routing table structure.

TABLE 1

| | | Next hop | Next hop |
|---|---|---|---|
| | Domain ID | gateway ID | gateway address |
| 1 | D1 | GW1 | mac₁ |
| 2 | D2 | GW2 | mac₂ |

As illustrated in Table 1, the ID (GW1) and address (mace) of the next hop gateway destined to the domain ID D1 can be stored, and the domain ID D1 functions as a destination ID.

The path search processor 15 locates a destination and then searches for a path to the destination, based on global topology information, when a particular terminal wants to find a destination to communicate with. The path search processor 15 receives next hop address information for the destination from the routing table manager 14, based on the domain 1D for the destination.

The forwarding cache storage 16 stores the next hop address information for the destination communication object. The routing table manager 14 manages information on destination domains, and the forwarding cache storage 16 manages only the information on the destination communication object, which is a destination domain where communication substantially occurs, and manages this information using a forwarding cache table. The information on the destination communication object stored in the forwarding cache storage 16 is temporarily stored path information, and the forwarding cache table may further include a path invalidation time when the temporarily stored path information becomes invalid.

Meanwhile, if there is change in link state information of upper- and lower-level domains and peer domains, the policy manager 17 requests the controller 11 to change the link state information by the link state manager 12. Accordingly, the link state manager 12 re-organizes the global topology based on the link state caused by the change reflected in the topology manager 13. In addition, the link state manager 12 requests the forwarding cache storage 16 to monitor forwarding caches and delete forwarding cache tables that have not been used for a specific length of time.

Next, a routing method in accordance with an exemplary embodiment of the present invention will be described, based on the foregoing routing apparatus.

In ID-based communication, an ID does not contain location information. Thus, a communication object intending to communicate has to acquire location information (Locator) of a destination communication object by using the ID of the destination communication object. Using the location information about the ID of the destination communication object, a forwarding path is established between a source ID and a destination ID, and communication is conducted between the two communication objects. A path search is performed in order for each gateway placed on a forwarding path to calculate the address of the next hop. The routing apparatus in accordance with the exemplary embodiment of the present invention selects information by performing LPM (longest prefix match) based on a routing table using global topology information and location information (domain ID) of the ID of a destination communication object.

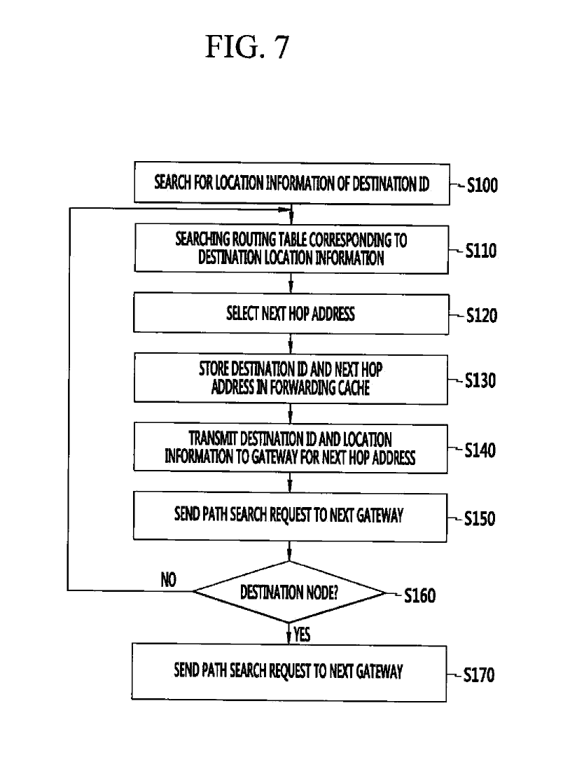

FIG. 7 is a flowchart of a routing method in accordance with an exemplary embodiment of the present invention.

A source communication object, i.e., source node, searches for location information of the ID of a destination communication object. The routing apparatus 1 searches for the location information (locator), i.e., domain ID, of the destination communication object ID by searching the routing table based on the ID of the destination node, i.e., destination communication object, provided from the source node (S100 and S110). The domain ID of the destination communication object and the domain ID of the routing table are compared with each other, and next hop address information mapped to a domain ID with the largest number of matches is selected (S120).

The forwarding cache storage 16 of the routing apparatus 1 stores a pair of the domain ID, i.e., destination ID, corresponding to the ID of the destination communication object, and the next hop address in a forwarding cache table (S130). In this way, in the event of communication with a specific destination ID, a message forwarding path is found by searching the routing table, the found message forwarding path is stored in a separate table, and unnecessary message forwarding path information is not stored in the routing table, thereby reducing the size of the routing table.

Next, the routing apparatus 1 sends a path search request to the gateway corresponding to the next hop address selected in S120 while sending the ID and location information of the destination communication object (S140 and S150). If the gateway corresponding to the next hop address that has received this path search request is not the destination node (S160), the ID of the destination communication object and information in the routing table of the gateway are compared with each other in the same way as the source node, thus selecting next hop address information (S110-S160). This process is repeatedly performed until the destination node is found.

As discussed above, the process of finding the gateway for the next hop address and sending a search request to the gateway is repeatedly performed until the destination node is found. Then, a forwarding path is established between the source node and the destination node, and communication between the two nodes is performed (S170).

According to an embodiment of the present invention, the problem of performance degradation arising from the trend of increasing inter-domain BGP (border gateway protocol) routing tables can be solved by managing address information for a specific destination domain, rather than by hierarchically organizing a global network topology and including routing information for all network addresses based on the global network topology. Since the size of a network topology graph can be scaled down when organizing a network topology, network scalability is achieved.

The embodiments of the present invention may not necessarily be implemented only through the foregoing devices and/or methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for routing in an ID-based communication system, the method comprising:
creating a hierarchical network topology by using link state information on higher-level domains, lower-level domains, and peer domains;
making a routing table based on the hierarchical network topology; and
performing routing by using the routing table,
wherein the routing table stores address information for a destination domain.

2. The method of claim 1, wherein the address information for the destination domain comprises the ID and address of the gateway for a next hop, corresponding to the destination domain.

3. The method of claim 1, wherein
the creating of a hierarchical network topology comprises:
sending a notification about the link state of level n, along with a single domain ID assigned to the domains at level n, to a first domain at level n−1 of the link state of level n from a gateway connected to a domain at level n, each domain having one or more gateways which connect to the outside;
sending a notification about the link state of a peer domain at level n−1 to the first domain from the peer domain; and
creating a network topology, based on the link state notifications, by a routing apparatus of a gateway connected to the first domain at level n−1.

4. The method of claim 3, wherein the domain ID assigned to the domains at level n indicates that the domains at level n are a single node belonging to level n−1.

5. The method of claim 3, wherein the routing method further comprises forwarding all the link state notifications from the domains at level n−1 and level n to a domain at level n+1.

6. The method of claim 3, wherein, in the creating of a hierarchical network topology, the hierarchical network topology is created based on a fisheye technique.

7. The method of claim 1, wherein
the performing of routing comprises:
receiving an ID of a destination node by a source node's routing apparatus;
searching for a destination domain ID by searching the routing table based on the ID of the destination node;
selecting next hop address information mapped to the destination domain ID from the routing table; and
transmitting the ID and location information of the destination node to a gateway corresponding to the next hop address information.

8. The method of claim 7, further comprising storing and managing the destination domain ID and the next hop address information mapped thereto in a forwarding cache table.

9. An apparatus for routing in an ID-based communication system, the apparatus comprising:
a link state manager that manages link state information on higher-level domains, lower-level domains, and peer domains;
a topology manager that creates a hierarchical network topology by using the link state information;
a routing table manager that makes a routing table based on the hierarchical network topology and stores and manages the routing table; and
a path search processor that performs a path search by using the routing table,
wherein the routing table stores address information for a destination domain.

10. The apparatus of claim 9, wherein the address information for the destination domain comprises the ID and address of the gateway for a next hop, corresponding to the destination domain.

11. The apparatus of claim 9, wherein
the topology manager creates a network topology, based on the link state of a higher level, along with a single domain ID assigned to the domains at the higher level, received from a gateway connected to a domain at the higher level, and the link state of a peer domain at the same level received from the peer domain, and
the single domain ID assigned to the domains at the higher level n may indicate that the domains at the level n are a single node belonging to the level where the routing apparatus is located.

12. The apparatus of claim 11, wherein the path search processor searches for a destination domain ID by searching the routing table based on the ID of the destination node, and transmits the ID and location information of the destination node to a gateway corresponding to next hop address information mapped to the destination domain ID from the routing table.

13. The apparatus of claim 12, further comprising forwarding cache storage that stores and manages the destination domain ID and the next hop address information mapped thereto in a forwarding cache table.
